(19) United States
(12) Patent Application Publication
(10) Pub. No.: US 2026/0132903 A1
(43) Pub. Date: May 14, 2026

(54) Lighting Device for Rear-View Device of Vehicle

(71) Applicant: Motherson Innovation Company Limited, London (GB)

(72) Inventors: Alf LIESNER, Bruchköbel (DE); Stefanie GÖTTLICHER, Bruchköbel (DE); Dominik ERNEWEIN, Bruchköbel (DE); Oliver SCHMIDT, Stuttgart (DE)

(21) Appl. No.: 19/121,505

(22) PCT Filed: Oct. 31, 2023
(86) PCT No.: PCT/EP2023/080355

§ 371 Date: Apr. 16, 2025

(30) Foreign Application Priority Data
Nov. 1, 2022 (DE) 10 2022 128 894.3

(51) Int. Cl. F21S 43/235; F21W 103/25

(52) U.S. Cl. CPC F21S 43/235; F21W 2103/25

(57) ABSTRACT

The disclosure relates to a lighting device for an external rear-view device of a vehicle comprising: a lighting unit, having at least one light source and at least one light guide in optical communication with the at least one light source; a housing, having an upper housing portion and a lower housing portion, with the lighting unit between the upper housing portion and the lower housing portion, wherein the upper housing portion and the lower housing portion form a groove therebetween on the outside of the housing, the upper housing portion, in particular a bottom section of the upper housing portion, defines a top edge and the lower housing portion, in particular a top section of the lower housing portion, defines a bottom edge, the groove is extending between the top edge and the bottom edge, and a virtual sphere contacts the top edge and the bottom edge, but provides a gap towards the at least one light guide such that the at least the at least one light guide is positioned within the groove and the top edge as well as the bottom edge are defining the outermost regions of the housing. The disclosure also relates to a rear-view device with such a lighting device and a vehicle with such a rear-view device.

### CROSS-REFERENCE TO RELATED APPLICATIONS

This application is a national-stage filing of International Patent Application No. PCT/EP2023/080355, filed on Oct. 31, 2023, which claims priority to German Patent Application No. DE 10 2022 128 894.3, filed on Nov. 1, 2022, each of which is incorporated herein by reference.

### FIELD

The disclosure relates to a lighting device of a vehicle. More particularly, the disclosure relates to a lighting device for an external rear-view device of a vehicle in line with the pre-amble of claim 1, said lighting device especially providing a turn light signal of the rear-view device by providing a thin line of light. The disclosure further relates to a rear-view device with such a lighting device and a vehicle with such a rear-view vehicle.

### BACKGROUND

Vehicles generally includes rear-view devices mounted inside and outside the vehicle. The rear-view devices generally include one or more mirrors, cameras or any combination thereof for viewing a scenario at least around the rear-end of the vehicle and at least one lighting device.

A lighting device is known for example from U.S. Pat. No. 10,800,322 B2, wherein a light guide device on the one hand, and a housing device and/or a lens on the other hand, are at least in some areas connected to one another by means of overmolding at least in some areas of the light guide device.

U.S. Pat. No. 7,357,542 B2 refers to an external rear-view mirror for vehicles, comprising: a mirror head fixedly secured to the vehicle; a housing defining an opening and a housing rear wall, said housing rear wall defining a recess extending along a portion thereof; a turn-signal lamp for generating light, said turn-signal lamp fixedly secured to said housing rear wall and extending into said recess, said turn-signal lamp including a light lens covering said turn-signal lamp and defining an outside surface and an opening extending through said light lens; and an optical waveguide having a source portion end extending through said opening in said light lens for guiding the light generated by said turn-signal lamp outside said light lens and around said mirror head, said optical waveguide having a remaining portion fixedly secured to said outside surface of said light lens.

An external rear-view mirror for a vehicle, including a mirror head with a housing in which at least one light area is arranged via a turn light signal device with a light window and a turn light back plate and at least one color emitting light source, is described in U.S. Pat. No. 7,850,350 B2. The light window is a fully transparent light guide for the color emitting light source, and the turn light signal device includes a separate color screen in front of a reflector visible through the light window positioned in a way the light of the light source is not passing directly though the color screen. The color screen may be structured in a defined design to fill at least a part of the lighting device.

A door mirror, which has a turn lamp that can be mounted without an increased size is known from DE 11 2008 002 757 T5. Said turn lamp has a housing and an outer lens that are formed by molding. A light emitting diode is mounted in the housing, and the outer lens covers the housing. The housing and the outer lens are integrated by a joint produced by injection molding and placed at a butt section at which the housing and the outer lens are butted together.

The term “vehicle” denotes any motor driven vehicle with or without trailers driven by a driver, where the driver requires information about people, other vehicles or objects in the (near) surrounding of the vehicle to be able to drive safety. As an example, vehicles are cars, trucks, tractors or trailers.

The term “driver” and “driver of the vehicle” relates here to the person controlling the main parameters of the vehicle, such as for example direction, speed and/or altitude, e.g. normally the person located in the location specified for the controlling person, for example a seat, but can also relate to any other person or entity within or outside of the vehicle.

The term “rear-view” is here defined as a view of the surrounding area of a vehicle, which is not in the field of view of a driver of the vehicle, i.e. the directions opposing, left, right, below and above of the viewing direction, but can also comprise the view in the direction of the viewing direction of the driver and/or any combinations of the directions.

The term “light source” denotes a device from which light originates and is emitted. The light source may include one or more light emitting devices or solid-state light sources. The term “solid state” generally refers to light emitted by solid-state electroluminescence, as opposed to incandescent bulbs or fluorescent tubes. For example, the light source may include a semiconductor light emitting diode (LED) or laser diode, an OLED, polymer light emitting diode (PLED), an LED lamp package, LED chip or LED die, or an array of one or more of these devices. It should be understood that the light source may also include a color changing LED, that is the LED may be configured to change color when required.

The term “lightguide” denotes a light conducting element at least partly forming part of a housing, wherein the lightguide has a light receiving surface within an enclosure, which may be provided at least partly by the housing, and a light emitting surface outside the enclosure, such that light emitted from the light source is received by the light receiving surface of the lightguide and directed towards the light emitting surface of the lightguide, such that light is emitted from the lightguide. The lightguide may be made of transparent material. The light may be emitted from the lightguide with a uniform luminance throughout the light emitting surface.

The term “reflective element” denotes a reflective surface on which light, for example emitted from a lightguide, falls and gets reflected in a reflecting direction to emit a reflected light. The reflective element may be a polished or a coated surface providing a mirror-like surface finish.

Different functions and devices can be incorporated into and/or controlled with the help of a rear-view device. Of particular interest are functions and devices to enhance, extend and/or sustain the functionality of the rear-view device during normal or extreme conditions. This can comprise heating and/or cooling means; cleaning means such as wipers, liquid and/or gaseous sprays; actuator means for moving the rear-view device or parts of it, such as for example a display, a camera system and/or parts of a camera system, comprising for example lenses, filters, light sources, adaptive optics like deformable mirrors, sensors and/or mirrors; and/or actuator means for inducing movement of other objects, for example parts of the vehicle and/or objects surrounding the vehicle. Furthermore, it can comprise linear tracks and/or rotating wheels, like for example a filter wheel, for exchanging optical elements, comprising for example lenses, mirrors, light sources, sensors, adaptive optics like deformable mirrors and/or filters.

Prominent examples for functions and devices incorporated into and/or controlled with the help of rear-view devices comprise lighting devices, for example any kind of light modules like an external light module, an internal light module, a front light, a back light, a fog light, a brake light, an acceleration light, a turn signal, a logo lamp, a puddle light, a flash light, a navigation light, a position light, an emergency light, a spotlight, a green light, a red light, a warning light, a turn signal light module, an approach light, a search light, an information light, a display and/or any combination thereof.

In recent years, lighting devices for vehicles have become important for their aesthetic appeal to consumers. Thus, vehicle manufacturers have made efforts to design vehicle lighting devices in consideration of the styling of the vehicles on which the lighting devices are mounted. Further, vehicle manufacturers may provide optional lighting effects (in addition to the legally required lighting functionality) to enhance vehicle styling.

It is difficult to provide aesthetically appealing vehicle lighting devices that meet required technical specifications. For example, taillights on existing cars tend to be power hungry and need various components, such as reflectors. Head lamps are similar in that they require multiple components, such as reflectors, cut off devices and the like. Aesthetic lighting effects lead to an even greater number of components and complexity. Such vehicle lighting devices are not easily adapted to the styling of the vehicle.

Rear-view devices having lighting devices for providing a signal such as a turn signal, warning light, fog light etc. are commonly used in a vehicle. These lighting devices not only enhance or extend the functionality of the rear-view devices of the vehicle but also provides aesthetic appeal to the vehicles. The lighting devices of the rear-view devices may include a light source such as a light emitting diode (LED) and a lightguide which get illuminated to provide light signal outside the vehicle. These lighting devices may further be enhanced to emit a thin line of light, which not only provides lighting functionality to the respective vehicle but also provides aesthetic appeal and enhances styling of the vehicle.

### SUMMARY

It is an object of the present disclosure to further develop the known lighting device for a rear-view device of a vehicle to overcome the drawbacks of the prior art such that enhanced lighting functionality as well enhanced aesthetic appeal of the vehicle are provided.

Thus, a lighting device for an external rear-view device of a vehicle is provided, which comprises: a lighting unit, having at least one light source and at least one light guide in optical communication with the at least one light source; a housing, having an upper housing portion and a lower housing portion, with the lighting unit between the upper housing portion and the lower housing portion, wherein the upper housing portion and the lower housing portion form a groove therebetween on the outside of the housing, the upper housing portion, in particular a bottom section of the upper housing portion, defines a top edge and the lower housing portion, in particular a top section of the lower housing portion, defines a bottom edge, the groove is extending between the top edge and the bottom edge, and a virtual sphere contacts the top edge and the bottom edge, but provides a gap towards the at least one light guide such that the at least one light guide is positioned within the groove, and the top edge as well as the bottom edge are defining the outermost regions of the housing.

It is proposed that the virtual sphere has a radius between 5 to 100 mm, in particular of 50 mm.

Embodiments of the invention are characterized in that the top edge is defined relative to the lighting unit, in particular as the top edge of the lighting unit, and the bottom edge is defined relative to the lighting unit, in particular as the bottom edge of the lighting unit.

Further, the top edge may be defined by an upper flange of the lighting unit and/or a change of curvature and the bottom edge may be defined by a lower flange of the lighting unit and/or a change of curvature.

It is also proposed that the at least one light source is positioned adjacent to the at least one light guide in a direction substantially towards an interior of the housing and/or the at least one light source is positioned adjacent to the at least one light guide in a direction substantially towards the vehicle.

Further, it is proposed that the upper flange portion abuts on the at least one light guide of the lighting unit, and/or the lower flange portion abuts on the at least one light guide of the lighting unit.

In addition, embodiments may be characterized in that the upper flange portion at least partially surrounds the at least one light guide of the lighting unit, and/or the lower flange portion at least partially surrounds the at least one light guide of the lighting unit.

The lighting unit may comprise a lighting source housing. In this respect, it is proposed that the lighting source housing at least partially surrounds the upper flange portion and the lower flange portion, and/or the lighting source housing is at least temporarily secured to the upper and the lower flange portions.

It is also proposed that the lighting unit or the lighting source housing comprises the upper flange and the lower flange, wherein the upper flange connects the upper housing portion with the light guide, and the lower flange connects the lower housing portion with the light guide.

Further, it may be that the lighting unit comprises a unitary flange, and the unitary flange comprises the lower flange and the upper flange.

Still further embodiments may be characterized in that the light guide is thin in a substantially vertical direction when the lighting device is attached to the vehicle via the rear-view device, and/or the light guide has sharp edges at its light emitting side and/or has its surface at the light emitting side provided with a surface treatment, such that the light emitted from the light guide appears as a line of light and/or has a laser like appearance.

The invention also provides a rear-view device comprising at least one lighting device in line with the present disclosure.

Still further, a vehicle is provided comprising at least one rear-view device according to the present disclosure.

### BRIEF DESCRIPTION OF THE DRAWINGS

Other aspects, advantages, and salient features of the present disclosure will become apparent to those skilled in the art from the following detailed description, which taken in conjunction with the annexed figures, discloses exemplary embodiments of the disclosure, wherein:

FIG. 1 illustrates a perspective front view of a vehicle.

FIG. 2 illustrates a cross-sectional view of a lighting device.

FIG. 3 illustrates a cross-sectional view of a lighting device in accordance with a first embodiment of the present disclosure.

FIG. 4 illustrates a cross-sectional view of another lighting device.

FIG. 5 illustrates a cross-sectional view of a lighting device in accordance with a second embodiment of the present disclosure.

FIG. 6 illustrates a cross-sectional view of a further lighting device showing a virtual sphere.

FIG. 7 illustrates a cross-sectional view of a lighting device in accordance with a third embodiment of the present disclosure and showing a virtual sphere.

FIG. 8 illustrates a cross-sectional view of a still further lighting device showing a virtual sphere.

FIG. 9 illustrates a cross-sectional view of a lighting device in accordance with a fourth embodiment of the present disclosure and showing a virtual sphere.

FIG. 10 illustrates a perspective view of a rear-view device having a lighting device in accordance with FIG. 2.

FIG. 11 illustrates a perspective view of a rear-view device having a lighting device in accordance with FIG. 3.

### DETAILED DESCRIPTION

It is to be understood that the embodiments described are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

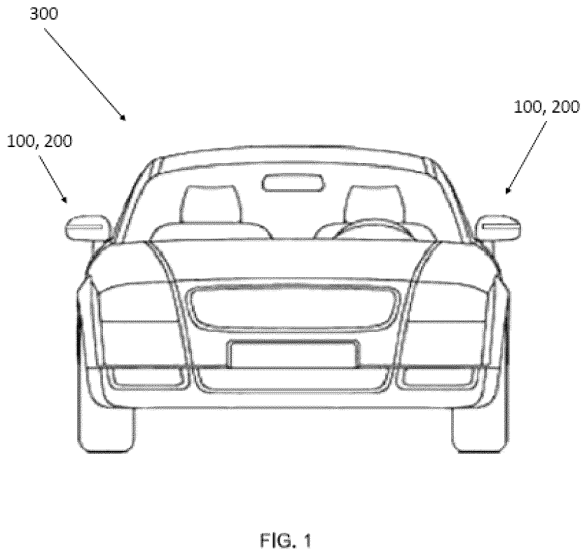

FIG. 1 shows a front view of a vehicle 300 having a rear-view device 200 and a lighting device 100 according to the present disclosure. The lighting device 100 may be disposed on or integrated in the rear-view device 200. The vehicle 300 may comprise two rear-view devices 200, one on the left side and one on the right side of the vehicle 300.

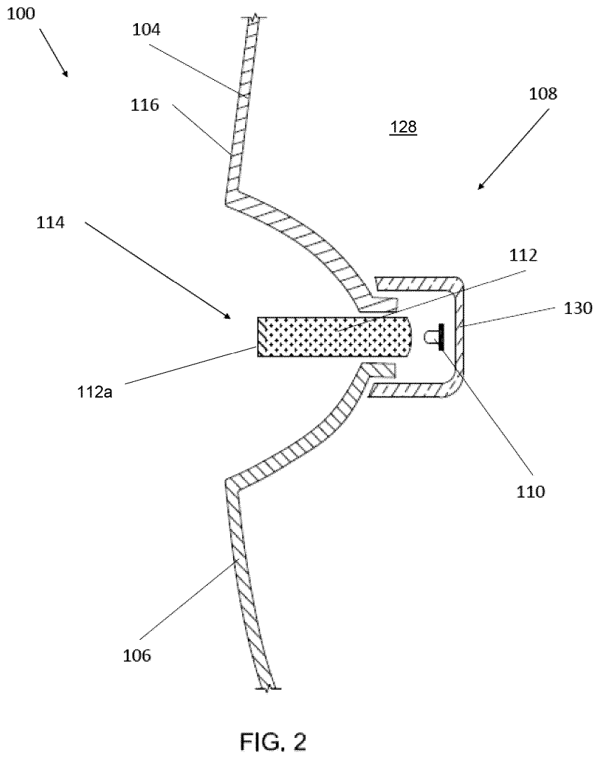

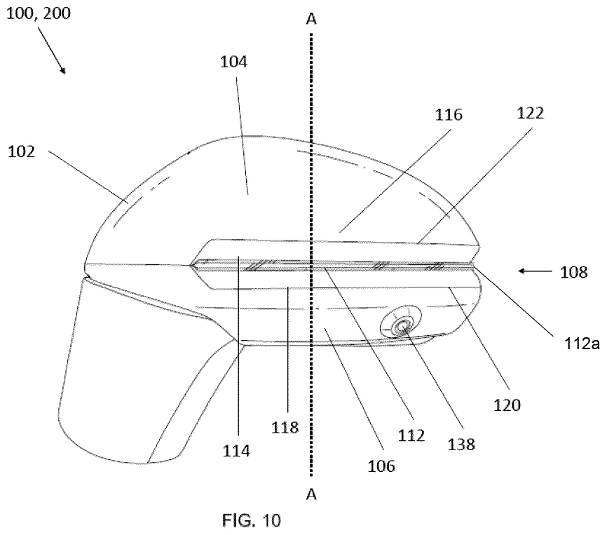

FIG. 2 shows a cross-sectional view of the lighting device 100 taken across line A-A as shown in FIG. 10, with the interior 128 of the rear-view device 200 being shown on the right side. The rear-view device 200 and/or the lighting device 100 comprises a housing 102 mounted to the vehicle 300 via a foot 400 as shown in FIGS. 1 and 10. The housing 102 comprises an upper housing portion 104 and a lower housing portion 106. The upper housing portion 104 and the lower housing portion 106 are secured at least to each other to form the housing 102.

The lighting unit 108 may be secured and positioned between the upper housing portion 104 and the lower housing portion 106. In one embodiment the lighting unit 108 comprises at least one light guide 112, at least one light source 110, and a lighting source housing 130. The at least one light source 110 is in optical communication with the at least one light guide 112. The upper housing portion 104 may abut on the at least one light guide 112 of the lighting unit 108 and the lower housing portion 106 may abut on the at least one light guide 112 of the lighting unit 108. But there are also embodiments with a gap between the light guide 112 and the housing portions 104, 106, depending on the attachment structure.

The at least one light source 110 produces light and may transmit the light through the at least one light guide 112. The light transmitted through the at least one light guide 112 may be visible outside of the housing 102 in a direction substantially forward and substantially outward relative to the vehicle 300. The at least one light source 110 may be positioned adjacent to the at least one light guide 112 in a direction substantially towards the interior 128 of the housing 102. The lighting source housing 130 may partially be surrounded by and secured to the upper housing portion 104 and the lower housing portion 106. The lighting source housing 130 substantially encloses the at least one light source 110 and a portion of the at least one light guide 112.

In the first embodiment as shown in FIG. 2, the upper housing portion 104 and the lower housing portion 106 form a groove 114 therebetween. The groove 114 may also be referred to as a recess. The at least one light guide 112 is positioned within the groove 114. The groove 114 and the at least one light guide 112 may be configured in such a way that the light emitted from the light guide 112 appears as a laser light from a view in front of or outwardly relative to the vehicle 300. Or said another way, the light guide 112 is very thin in a vertical direction and appears as a fine line of light when viewed from outside the vehicle 300. The laser like appearance of the light emitted from the light guide 112 may be considered aesthetically pleasing.

In detail, the at least one light guide 112 may be in form of a thin rod with a light receiving side facing the at least one light source 110 as well as being arranged within the interior 128. A light emitting side of the at least one light guide 112, opposite the light receiving side, may be defined by sharp edges to provide the fine line of light output. The sharp edges of the light emitting side have to be arranged within the groove 14 and are not to extend to the outside and, thus, beyond the housing 102, to avoid any injuries. Further, the light emitting side of the at least one light guide 112 may have a treated surface 112a to provide light scattering centers and, thus, a homogenous as well as sharp light output.

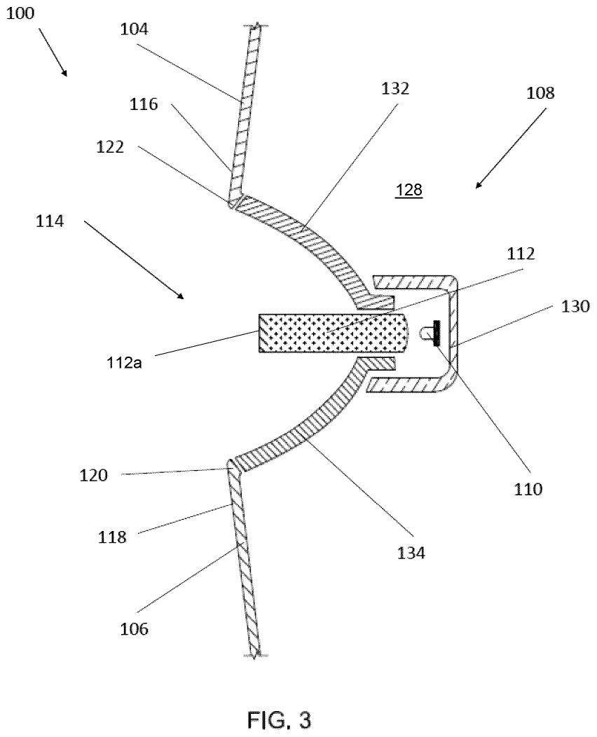

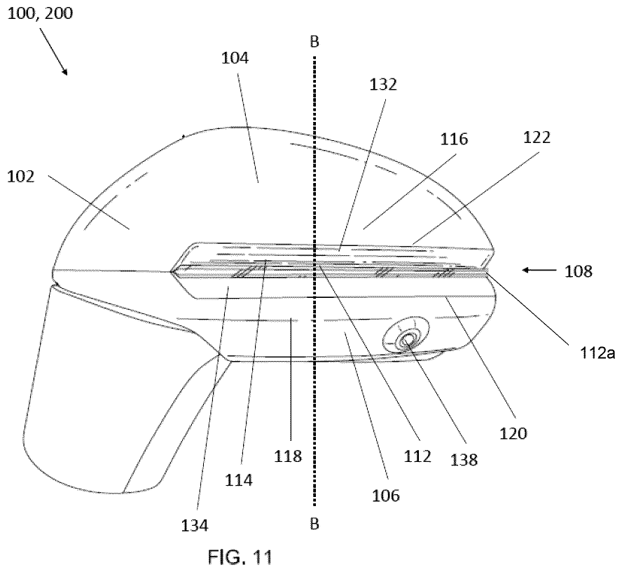

FIG. 3 shows a cross-sectional view of a second embodiment of the lighting device 100 taken across line B-B as shown in FIG. 11. The lighting device 100 comprises the housing 102, which comprises the upper housing portion 104, the lower housing portion 106, and the lighting unit 108. The upper housing portion 104 and the lower housing portion 106 are at least secured to each other to form the housing 102.

As shown in FIG. 3, the upper housing portion 104 may have a bottom section 116 defining a top edge 122. The lower housing portion 106 may have a top section 118 defining a bottom edge 120. The lighting unit 108 further comprises an upper flange 132 and a lower flange 134. The upper flange 132 may connect the upper housing portion 104 with the light guide 112 and the lighting source housing 130. The lower flange 134 may connect the lower housing portion 106 with the light guide 112 and the lighting source housing 130. It is important that the surface 112a at the light emitting end of the light guide 112 does not extend beyond the edges 120 and 122 and, thus, remains within the gap 114.

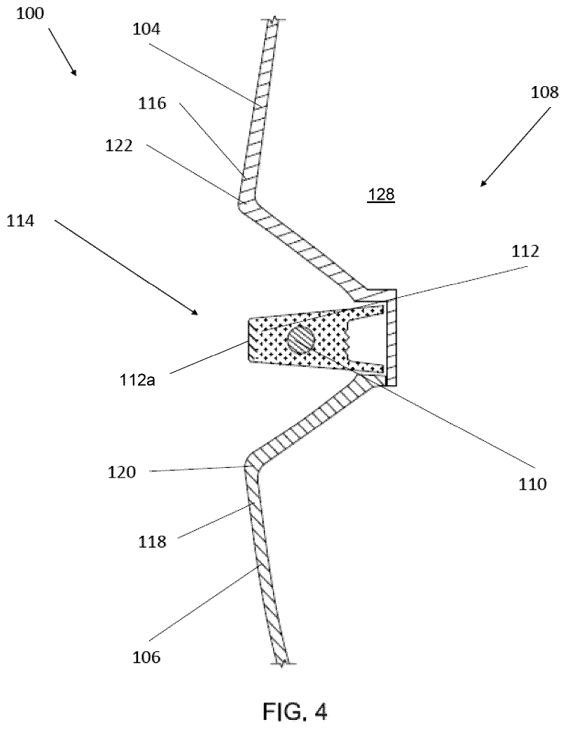

FIG. 4 shows a cross-sectional view of the lighting device 100 of a third embodiment, wherein the upper housing portion 104 may abut on and partially surround the light guide 112. The lower housing portion 106 may be configured to contact the upper housing portion 104 in a direction substantially towards the interior 128 of the rear-view device 200. This configuration does not necessitate a lighting source housing 130, as the upper housing portion 104 and lower housing portion 106 come together to position the at least one light source 110 adjacent to the at least one light guide 112 in a direction substantially towards the vehicle 300.

In another, not shown embodiment, the lower housing portion 106 may abut and partially surround the at least one light guide 112 of the lighting unit 108. But, the edges 120 and 122 always define the most exterior parts of the rear-view device 200 opposite the interior 128 and in a direction substantially facing away from the vehicle 300.

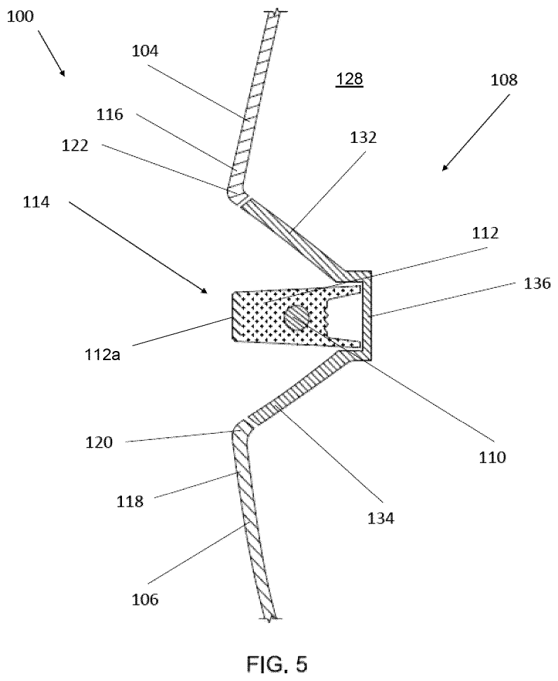

The cross-sectional shape of the light guide 112 may vary from a rectangular shape as shown in FIGS. 2 and 3 to a slightly trapezoidal shape as shown in FIGS. 4 and 5.

FIG. 5 shows a cross sectional view of the lighting device 100 of a fourth embodiment, wherein the lighting device 100 comprises the housing 102, and the housing 102 comprises the upper housing portion 104, the lower housing portion 106, and part of the lighting unit 108. The upper housing portion 104 may have the bottom section 116 defining the top edge 122. The lower housing portion 106 may have the top section 118 defining the bottom edge 120. The lighting unit 108 further comprises a unitary flange 136. The unitary flange 136 comprises the lower flange 134 and the upper flange 132. The upper flange 132 may connect the upper housing portion 104 with the light guide 112. The upper flange 132 may connect to the upper housing portion 104 at the top edge 122 of the lighting unit 108. The lower flange 134 may connect the lower housing portion 106 with the light guide 112. The lower flange 134 may connect to the lower housing portion 106 at the bottom edge 120 of the lighting unit 108.

As shown in FIG. 5, the unitary flange 136 partially surrounds the at least one light source 110 in a direction substantially towards the interior 128 of the housing 102. Furthermore, the at least one light source 110 is positioned in the direction substantially towards the vehicle 300, whereas the surface 112a of the light guide 112 pointing away from the interior 128 is arranged within the gap 114, not extending beyond the edges 120 and 122 to the outside.

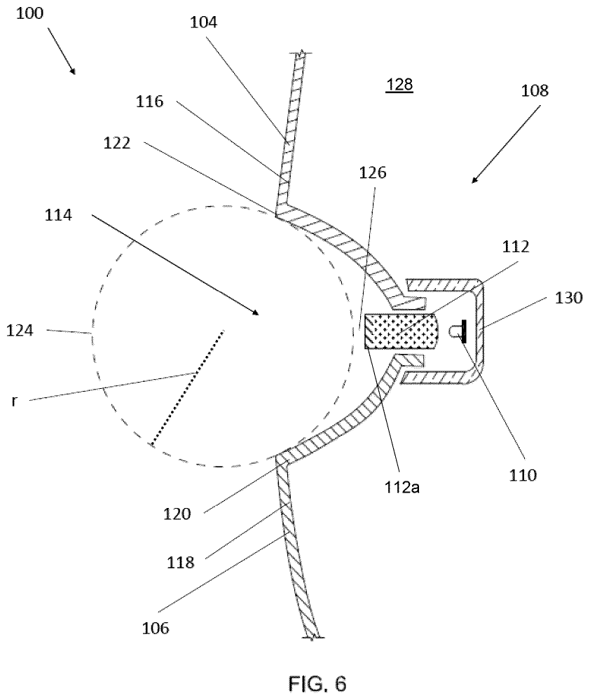

FIG. 6 shows a cross-sectional view the lighting device 100 according to a fifth embodiment being in analogy to the first embodiment of FIG. 2, but with a shorter light guide 112 and further showing a virtual sphere 124. In FIG. 6, in addition, a top edge 122 and a bottom edge 120 are marked in the region of a change of curvature of the upper housing portion 104 and the lower housing portion 106, respectively. The virtual sphere 124 may also be referred to as a sphere and is no physical part of the lighting device 100. The virtual sphere 124 may be used as a measurement or configuration tool for ensuring that the surface 112a of the light guide 112 remains within the gap 114. The virtual sphere 124 contacts or touches the upper housing portion 104 and the lower housing portion 106 at the top edge 122 and bottom edge 120, respectively and simultaneously. The virtual sphere 124 projects into the groove 114 and does not contact the lightguide 112. The virtual sphere 124 has a radius r, which may range from 5 mm to 100 mm. The radius r of the virtual sphere 124 may preferably be 50 mm. Additionally, there is a gap 126 between the virtual sphere 124 and the light guide 112, i.e. the surface 112a of the light guide 112. The virtual sphere 124 may be used to determine the depth of the light guide 112 within the groove 114. If the virtual sphere 124 has a larger radius r, then the light guide 112 may be deeper within the groove 114. Said in another way, the larger the virtual sphere 124 the shorter the light guide 112 in a horizontal direction. Conversely, if the virtual sphere 124 has a smaller radius r, then the light guide 112 may become longer. Said in still another way, the smaller the virtual sphere 124 the longer the light guide 112 in the horizontal direction. The lighting device 100 may be configured in this way to create the laser-like appearance of light emitted from the light guide 112.

FIG. 6 shows a representation of the virtual sphere 124 which may not be drawn to scale. However, it is contemplated that the radius r of the virtual sphere 124 may have a radius r of 5 mm to 100 mm.

The virtual sphere 124 contacts the top edge 122 and bottom edge 120 of the lower housing portion 106 and upper housing portion 104, respectively, and the depth of the virtual sphere 124 into the groove 114 with the gap 126 conforms the lighting device 100 to meet the requirements from various legal and safety entities. When there is a gap 126 between the light guide 112 and the virtual sphere 124 there is no legal or safety requirements as to the height of the light guide 112 in the vertical direction. As such, the height of the light guide 112 in the vertical direction may be less than 2.5 mm. In an example, the size and shape of the groove 114 may be configured or tailored to ensure there is a gap 126 between the virtual sphere 124 having a radius r of 50 mm and the light guide 112. This may allow the light guide 112 to be as short or thin in the vertical direction as wished to achieve an aesthetically pleasing appearance.

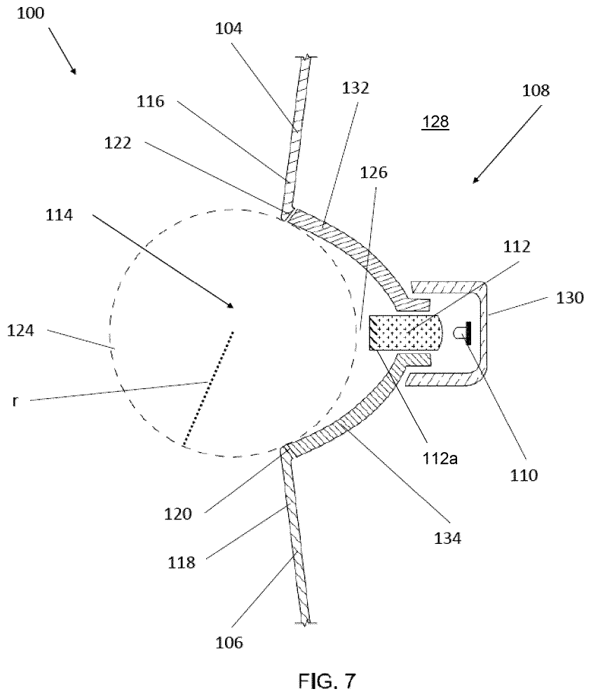

FIG. 7 shows a cross-sectional view of the lighting device 100 according to a sixth embodiment being in analogy to the second embodiment as shown in FIG. 3, but with a shorter light guide 112 and further showing the virtual sphere 124. The virtual sphere 124 having the same characteristic as described above.

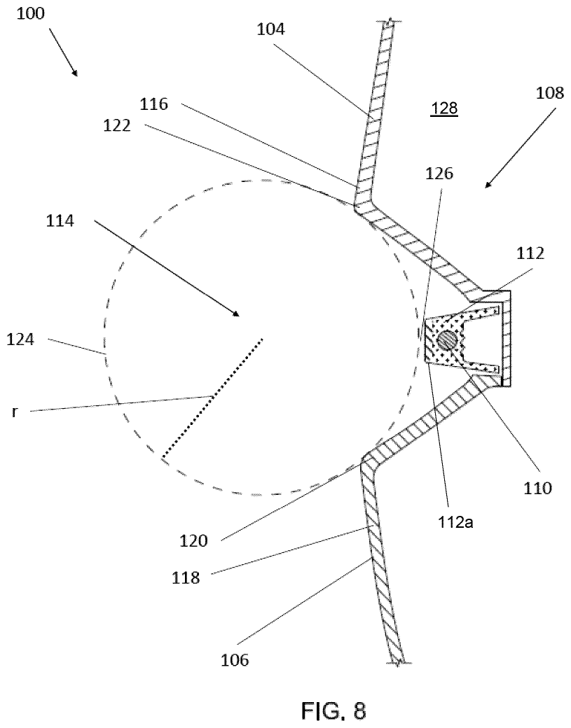

FIG. 8 shows a cross-sectional view the lighting device 100 according to a seventh embodiment being in analogy to the third embodiment as shown in FIG. 4, but with a shorter light guide 112 and further showing the virtual sphere 124. The virtual sphere 124 has the same characteristic as described above.

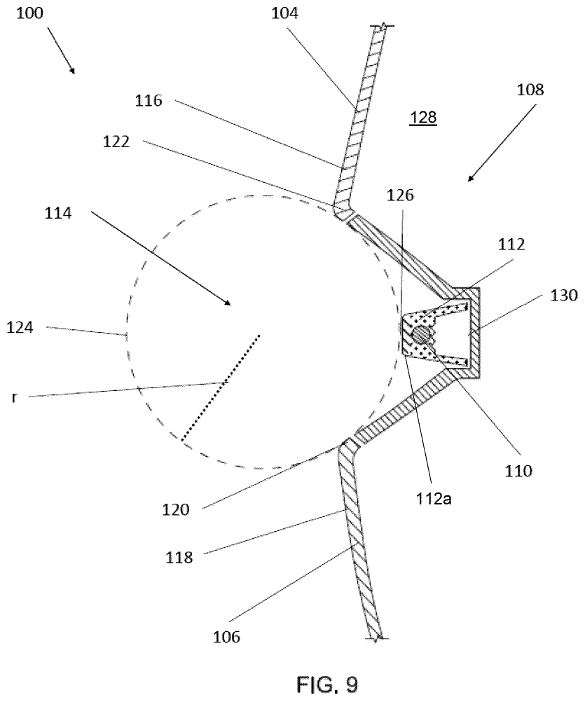

FIG. 9 shows a cross-sectional view the lighting device 100 according to a eighth embodiment being in analogy to the fourth embodiment of as shown in FIG. 5, but with a shorter light guide 112 and further comprising the virtual sphere 124. The virtual sphere 124 having the same characteristic as described above.

FIGS. 6-9 show cross-sectional views of the lighting device 100 as shown in FIGS. 2-5, respectively. The light guide 112 has to be positioned within the groove 114 in a direction substantially towards the interior of the housing 128 and the light guide 112 may have the laser-like appearance. The laser-like appearance may be described as a very thin line relative to a vertical direction. This appearance may be found to be aesthetically pleasing which may give the lighting device 100 and rear-view device 100 an overall aesthetically pleasing look, while also providing the rear-view device 200 with an additional safety and communication feature of a side turn indicator.

FIG. 10 shows a perspective view of the lighting device 100 and the rear-view device 200. The lighting device 100 comprises the housing 102. The housing 102 further comprising the upper housing portion 104, the lower housing portion 106, and part of the lighting unit 108. The upper housing portion 104 and the lower housing portion 106 are secured at least to each other to form the housing 102. The lighting unit 108 may be secured and positioned between the upper housing portion 104 and the lower housing portion 106. In one embodiment the lighting unit 108 comprises at least one light guide 112 and at least one light source (not shown). The upper housing portion 104 may have the bottom section 116 defining the top edge. The lower housing portion 106 may have the top section 118 defining the bottom edge 120.

FIG. 10 further shows the line A-A which may define a cross-section as described above. Also show in FIG. 10 is that the surface 112a of the light guide 112 remains within the gap 114 and is not extending beyond the housing 102. The housing 102 may be provided with additional features such as a camera 138 and a reflective element (not shown).

FIG. 11 shows a perspective view of the lighting unit 100 which may also be the rear-view device 200. The housing 102 comprises the upper housing portion 104, the lower housing portion 106, and part of the lighting unit 108. The upper housing portion 104 may have the bottom section 116 defining the top edge 122 of the lighting unit 108. The lower housing portion 106 may have the top section 118 defining the bottom edge 120 of the lighting unit 108. The lighting unit 108 further comprises the upper flange 132 and the lower flange 134. The upper flange 132 may connect the upper housing portion 104 with the light guide 112 and the lighting source housing 130 (not shown). The upper flange 132 may connect to the upper housing portion 104 at the top edge 122. The lower flange 134 may connect the lower housing portion 106 with the light guide 112 and the lighting source housing 130 (not shown). The lower flange 134 may connect to the lower housing portion 106 at the bottom edge 120.

FIG. 11 further shows the line B-B which may define a cross-section as described above. As can be seen from FIG. 11, the surface 112a of the light guide 112 remains within the gap 114 and is not extending beyond the housing 102. The housing may have additional features such as a camera 138 and a reflective element (not shown).

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. I.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

Reference Signs

| | |
|---|---|
| 100: | lighting device |
| 102: | housing |
| 104: | upper housing portion |
| 106: | lower housing portion |
| 108: | lighting unit |
| 110: | light source |
| 112: | light guide |
| 112a: | outer surface |
| 114: | groove (recess) |
| 116: | bottom section |
| 118: | top section |
| 120: | bottom edge |
| 122: | top edge |
| 124: | virtual sphere (ball) |
| 126: | gap |
| 128: | interior of the housing |
| 130: | lighting source housing |
| 132: | upper flange |
| 134: | lower flange |
| 136: | unitary flange |
| 138: | camera |
| 200: | rear-view device |
| 300: | vehicle |
| 400: | foot |
| A-A: | section line of FIG. 10 |
| B-B: | section line of FIG. 11 |
| r: | radius of virtual sphere |

1-11. (canceled)

12. A lighting device for an external rear-view device of a vehicle, comprising:
a lighting unit having at least one light source and at least one light guide in optical communication with the at least one light source;
a housing having two housing portions, wherein the lighting unit is arranged between the housing portions, wherein,
when the lighting device is attached to the vehicle via the rear-view device, the two housing portions are in form of an upper housing portion and a lower housing portion,
the upper housing portion and the lower housing portion form a groove therebetween on the outside of the housing,
the upper housing portion or a bottom section of the upper housing portion defines a top edge, and the lower housing portion or a top section of the lower housing portion defines a bottom edge, and
the groove is extending between the top edge and the bottom edge,
wherein,
the top edge is defined relative to the lighting unit as the top edge of the lighting unit, wherein the top edge is defined by an upper flange of the lighting unit,
the bottom edge is defined relative to the lighting unit as the bottom edge of the lighting unit, wherein the bottom edge is defined by a lower flange of the lighting unit, and
a virtual sphere contacts the top edge and the bottom edge, and provides a gap towards the at least one light guide such that the at least one light guide is positioned within the groove, and the top edge as well as the bottom edge are defining the outermost regions of the housing.

13. The lighting device according to claim 12, wherein the virtual sphere has a radius between 5 to 100 mm.

14. The lighting device according to claim 12, wherein the at least one light source is positioned adjacent to the at least one light guide in a direction substantially towards an interior of the housing.

15. The lighting device according to claim 12, wherein the at least one light source is positioned adjacent to the at least one light guide in a direction substantially towards the vehicle.

16. The lighting device according to claim 12, wherein the upper flange abuts on the at least one light guide of the lighting unit.

17. The lighting device according to claim 12, wherein the lower flange abuts on the at least one light guide of the lighting unit.

18. The lighting device according to claim 12, wherein the upper flange at least partially surrounds the at least one light guide of the lighting unit.

19. The lighting device according to claim 12, the lower flange at least partially surrounds the at least one light guide of the lighting unit.

20. The lighting device according to claim 12, wherein the lighting unit comprises a lighting source housing.

21. The lighting device according to claim 20, wherein the lighting source housing at least partially surrounds the upper flange and the lower flange.

22. The lighting device according to claim 20, wherein the lighting source housing is at least temporarily secured to the upper housing portion and/or upper flange and the lower housing portion and/or lower flange.

23. The lighting device according to claim 12, wherein
the lighting unit comprises a unitary flange, and the unitary flange comprises the lower flange and the upper flange, or
the lighting source housing comprises the upper flange and the lower flange,
wherein the upper flange connects the upper housing portion with the light guide, and the lower flange connects the lower housing portion with the light guide.

24. The lighting device according to claim 12, wherein
the light guide is thinner in a vertical direction than in a horizontal direction when the lighting device is attached to the vehicle via the rear-view device, and/or
the light guide has sharper edges at its light emitting side than at its light receiving side and/or has its surface at the light emitting side provided with a surface treatment,
such that the light emitted from the light guide appears as a line of light and/or has a laser like appearance.

25. A rear-view device comprises at least one lighting device according to claim 12.

26. A vehicle comprising at least one rear-view device according to claim 25.
